(19) United States
(12) Patent Application Publication
(10) Pub. No.: US 2012/0082182 A1
(43) Pub. Date: Apr. 5, 2012

(54) INTEGRATION OF AN OPTICAL WAVEGUIDE OF A SENSOR INTO A COMPONENT

(75) Inventor: Gereon Fehlemann, Dusseldorf (DE)

(73) Assignee: SMS SIEMAG AKTIENGESELLSCHAFT, Dusseldorf (DE)

(21) Appl. No.: 13/376,928

(22) PCT Filed: Jun. 8, 2010
(86) PCT No.: PCT/EP10/03414

§ 371 Date: Dec. 8, 2011

(30) Foreign Application Priority Data
Jun. 8, 2009 (DE) 10 2009 024 519.7
Oct. 15, 2009 (DE) 10 2009 049 479.0

(51) Int. Cl. G01K 11/32; C25D 5/10; C25D 5/00; C23C 4/06; B05D 5/06

(52) U.S. Cl. 374/161; 427/455; 427/162; 205/114; 374/E11.015

(57) ABSTRACT

The invention relates to a method for integrating an optical waveguide (3) of a temperature sensor and/or strain sensor into a temperature and/or strain measuring component (1) made of a base material (2), onto which a coating (5) is applied. The optical waveguide (3) is arranged on a predetermined measurement plane, whereupon a coating (5) is applied. The aim of the invention is to allow an optical waveguide (3) to be accurately integrated into and tightly joined to the body of a temperature and/or strain measuring component (1). Said aim is achieved by arranging the optical waveguide (3) within, on top of, or on a plane of the temperature and/or strain measuring component (1), said plane delimiting the base material (2) of the temperature and/or strain measuring component (1) and forming a predetermined measurement plane, and then applying a coating material (5a) to said plane of the temperature and/or strain measuring component (1) made of the base material (2) such that the coating is formed which integrally joins the optical waveguide (3) or a tube (4) surrounding the optical waveguide (3) to the base material (2) and/or to adjacent coated zones.

The invention relates to a method for integrating an optical waveguide of a temperature and/or strain sensor in a structural temperature and/or strain component composed of a basic material with a coating applied thereon, wherein the optical waveguide is arranged in a provided measuring plane, and subsequently a covering coating is applied.

The invention further relates to a measuring component with an integrated optical waveguide of a temperature and/or strain sensor which is composed of a basic material with a coating applied thereon, wherein the optical waveguide is arranged in a provided measuring plane and is covered by a coating.

It is known in the art to use optical waveguides for temperature measurements and to mount them in a temperature measuring component. Such a temperature measuring component may be a component, such as a temperature measuring probe which is mounted on a machine or plant element and has an embedded sensor for effecting temperature measurements on a machine or plant element, or a vessel or container containing a hot fluid, such as, for example, a heat exchanger or a furnace. In order to recognize the operating conditions and/or wear, the temperature is measured at the structural components, if necessary at several locations. For measuring the temperature, optical waveguides as sensors and measuring value pickups and corresponding evaluating units are known.

It is also known to use such optical waveguides for measuring mechanical strains or mechanical strain conditions. For this purpose, the optical waveguides are mounted as components of a strain measuring sensor for detecting mechanical strains in a strain measuring component whose mechanical strains are to be determined. Therefore, the term “strain measuring component” is used in the following. Glass fiber conductors or optical waveguides are also used for measuring mechanical strains. For this purpose, the respective optical waveguide fiber, particularly glass fiber, or a bundle of fibers must be fixedly integrated in the respective matrix, particularly the material matrix which surrounds it.

For temperature measurements, the optical waveguides, for example, in the form of glass fibers, are frequently received in a protecting metal pipe which is arranged at the location where the temperature of a component or a medium is intended to be measured. In order to be able to carry out a precise measurement, the metal pipe must rest as tightly and impermeably as possible without an air gap or intermediate space on the surface of the component or of the material or of the medium whose temperature is to be measured. In order to make this possible, the surface of the component has grooves or bores cut into the surface of the component in or on which the metal pipe rests. Because of the usual dimensional deviations and tolerances it is not ensured in this connection that the metal pipe rests in all cases tightly and directly against the surface and, thus, against the material of the component. In addition, depending on the geometric configuration of the component or the possible mechanical processing, this type of mounting an optical waveguide is subject to limitations.

U.S. Pat. No. 5,996,219 A discloses a method for encapsulating electrical or optical components of a sensor in high heat resistant metal. In this connection, on the coating of a substrate consisting of a basic material and a coating, an optical waveguide is placed and is embedded in another coating applied in several layers thereon, and which may also include metal. By encapsulating or embedding, a protection against harmful environmental influences is to be achieved. However, the temperature or strain measuring probe or similar components produced in this manner does not directly represent the component whose temperature or mechanical strain or similar variables should be measured. Rather, the probe is apparently still fastened to such a component. The encapsulating or embedding takes place with many different layers and is correspondingly cumbersome.

U.S. Pat. No. 6,944,360 B2 discloses a temperature/strain sensor which is embedded in high heat resistant metal. Also in this case, embedding is effected in several layers and is correspondingly cumbersome.

WO 2004/015349 A2 discloses a smelting furnace whose state of operation is monitored by means of optical waveguides. The optical waveguides are arranged between a refractory layer which surrounds a heat source and an outer wall of the smelting furnace. The optical waveguides are fastened, for example, on a flexible mat. An exact correlation of the measured temperatures to a narrowly limited measuring location is not possible because the temperatures are transmitted through radiation to the optical waveguides.

The invention is based on the object of providing a solution which makes it possible to achieve an exact and narrow integration and connection of an optical waveguide in or at the body of a temperature and/or strain measuring component.

In a method of the type described in more detail above, this object is met according to the invention in that the optical waveguide is mounted in, on, or at a plane of the temperature and/or strain measuring component which limits the basic material of the temperature measuring component and forms an intended measuring plane of the temperature and/or strain measuring component, and subsequently, on this plane of the temperature and/or strain measuring component formed of the basic material, a coating material is applied so as to form the coating, or a pipe which integrally surrounds the optical waveguide on the basic material and/or adjacent coating areas.

In a measuring component of the type described in more detail above, this object is met according to the invention in that the optical waveguide is arranged in, on, or at a plane of the temperature and/or strain measuring component limiting the basic material of the temperature and/or strain measuring component and a plane of the temperature and/or strain measuring component forming a measuring plane, and in this plane of the temperature and/or strain measuring component and formed from the basic material, by means of a coating which integrates the optical waveguide or a pipe surrounding the optical waveguide integrally to the basic material and/or adjacent coating areas.

The respective dependent Claims relate to advantageous embodiments and further developments.

In accordance with the invention, a temperature and/or strain measuring component is further developed and equipped in such a way that temperatures and/or strains prevailing in and/or at the component can be exactly measured and exactly locally assigned by means of the at least one optical waveguide which is integrated in this manner in the body of the temperature and/or strain measuring component or integrally attached to the body of the temperature and/or strain measuring component. Thanks to the invention, a temperature sensor or strain sensor or pressure sensor constructed in the form of an optical waveguide or comprising an optical waveguide can be mounted and integrated tightly and with immediate contact and directly in the body of a structural component or of a tool or plant or machine component of plant technology or machine technology or method technology. The optical waveguide which may be surrounded by a protective pipe is tightly and homogeneously and closed or covered by the coating and is fixed in this manner on or in the intended measuring plane. It is no longer necessary that first a single sensor with optical waveguide is to be constructed which would then have to be fastened to the tool or plant component with the attendant and above described problems. The optical waveguide is embedded in the coating or coatings and, thus, is completely covered by the coating and is protected as a result against mechanical and/or chemical influences.

The construction of a temperature and/or strain measuring component according to the invention is particularly advantageous when the location of the temperature and/or strain measurement component is near the heat-induced and temperature-induced and/or strain-induced surface of the temperature and/or strain measuring component and/or the latter has a complex and/or complicated shape and simultaneously a narrow, homogeneous integration of the optical waveguide is desired.

For producing an advantageous integration or connection of the optical waveguide, it is useful if in accordance with an embodiment of the invention initially that part of the temperature and/or strain measuring component which contains the measuring plane and consists of the basic material with applied coating is produced, and subsequently the coating is partially removed up to this measuring plane, at least one optical waveguide or an optical waveguide with surrounding pipe is arranged in this area, and finally the coating is built up again.

In this connection, the optical waveguide is in dependence on the selected coating method integrated directly without surrounding pipe or in the surrounding pipe, is placed and fixed on the produced measuring plane, and then the coating is built up again.

For the exact placement of the optical waveguide in the temperature and/or strain measuring component the invention further provides that in the measuring plane grooves are cut or holes bored in the basic material, and the optical waveguide or the pipe surrounding the optical waveguide are placed at least in areas or partially in a respective groove or respective hole, and the coating is applied. In this manner, the optical waveguide can be exactly fixed and positioned. Preferably, grooves having a diameter which corresponds to the diameter in the order of magnitude of about 100 to 150 μm are made in the measuring plane, wherein the optical waveguide is then placed without protective pipe and is then coated. However, it is also possible to make such grooves for optical waveguides arranged in a pipe.

Applied as a coating substance or a coating material, can be a substance which is the same as the basic material or a material which differs from the basic material, as also provided by the invention.

Suitable for coating are known coating methods. According to a further development of the invention, it is advantageous if the coating is applied by means of a thermal spray method or a galvanic or chemical coating method.

For applying and building up the coating are particularly suitable as thermal spray methods, for example, wire flame spray, plasma spraying, powder vapor spraying, high-speed flame spraying, or cold gas spraying. Since the thermal coating methods exert a high kinetic energy on the surface of the temperature and/or strain measuring component to be coated and the optical waveguide, the optical waveguide should in this case be in a surrounding and protecting type of metal, so that it is not damaged during the coating process. In contrast, the galvanic coating methods are chemical reaction methods which do not damage the respective optical waveguide of glass fiber.

A particularly favorable coating thickness is obtained in accordance with a further development of the invention is applied in a thickness of 200 μm-5 mm, particularly 200-250 μm. It is also possible that a coating having a thickness of more than 250 μm up to several millimeters is applied. In accordance with another alternative, the coating has a thickness of at least 1.5 times the diameter of the optical waveguide. As a result, the optical waveguide is securely and completely covered by the coating, wherein a certain wear of the coating is also permissible.

In order to be able to also manufacture plant components of heavy industry and to achieve a good temperature conductivity, it is in accordance with another development according to the invention an advantage that the basic material and the coating material are of metal or at least essentially of a metal.

The invention can be particularly advantageously used if the optical waveguide is arranged in, on or at such a temperature and/or strain measuring component which is a component of a structural part which receives and/or is surrounded by a hot fluid.

Particularly advantageously, the invention can be used in molds, mold plates or tube molds which are used for casting soft steel. Therefore, the invention is additionally distinguished by the fact that the optical waveguide is arranged in, on or at a temperature and/or strain measuring component which is part of or forms a mold, mold plate or tube mold.

In this connection, the optical waveguide can be arranged on the hot side as well as on the side with the cooling ducts of a mold, so that the invention provides in a further development that the at least one optical waveguide or the at least one pipe surrounding the optical waveguide is arranged on the hot side of a mold, mold plate or tube mold, as well as that the at least one optical waveguide or the at least one pipe surrounding the optical waveguide is arranged in a cooling duct on the side of a mold, mold plate or tube mold facing away from the hot side.

In this regard, a cooling duct can have a particular shape or configuration of a groove.

The temperature and/or strain measuring component is advantageously produced in accordance with one of the claims 1 to 11.

It is then also advantageous if the optical waveguide or the pipe surrounding the optical waveguide is embedded in the coating, wherein, further, the optical waveguide or the pipe surrounding the optical waveguide is arranged in a groove formed in the basic material, as also provided by the invention.

An advantageous thickness of the coating is according to the invention 200 to 250 μm. In this regard, a coating having a thickness of at least 1.5 times the diameter of an optical waveguide is beneficial because as a result, the optical waveguide is securely and completely covered by the coating and a certain wear of the coating is permissible.

In accordance with a further development of the invention, the temperature and/or strain measuring component can preferably be an integral component of a structural part which receives and/or surrounds a hot fluid, wherein additionally, in accordance with the invention, the temperature and/or strain measuring component is or forms a part of a mold, mold plate or tube mold.

Finally, the invention further provides that the at least one optical waveguide or the pipe surrounding the optical waveguide is arranged on the hot side of a mold, mold plate or tube mold and/or the at least one optical waveguide or the pipe surrounding the optical waveguide is arranged in a cooling duct on the side of a mold, mold plate or tube mold facing away from the hot side. However, it is also possible to arrange more than one optical waveguide on a temperature and/or strain component and, for example, to provide the hot side as well as the side of a mold having the cooling ducts with at least one optical waveguide.

In the following, the invention will be explained in more detail with the aid of an example shown in the drawing.

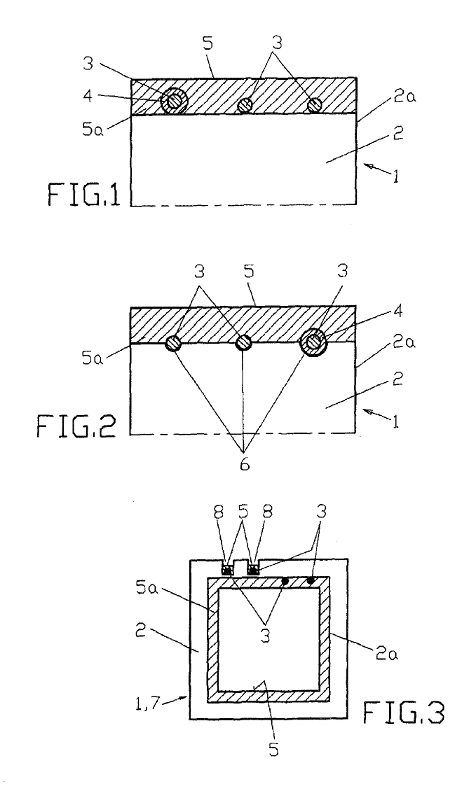

FIG. 1 is a schematic view showing portions of a cross section of a part of a temperature measuring component according to the invention, with three optical waveguides,

FIG. 2 is a schematic view showing portions of a cross section of a part of a temperature measuring component according to the invention, with three optical waveguides, wherein the optical waveguides are arranged in grooves, and

FIG. 3 is a schematic illustration of a cross section of a one-part or multiple-part tube mold.

FIG. 1 shows as a first embodiment a portion of a body of a temperature measuring component 1 which comprises a basic body 2a composed of a basic material 2. On a predetermined and fixed surface of the basic body 2a which defines the area of the basic material 2 and constitutes a measuring plane, three optical waveguides are arranged, wherein one of them is surrounded by a protective pipe or a pipe 4. It is to be observed in this connection that the temperature measuring component 1 as a rule has exclusively optical waveguides 3 of the same type; this means either those with or those without surrounding pipe 4. The optical waveguides 3 are placed tightly on the basic material 2 of the basic body 2a and are fixed in their position by means of a coating 5 formed of a coating material 5a, preferably a metal, and narrowly, tightly and homogenously surrounded by the coating 5. The thickness or width of the coating 5 is approximately 200 to 250 μm and, thus, about twice the diameter of conventional optical waveguides 3 of about 100 to 150 μm, wherein the possibly present protective pipe 4 is not taken into consideration here. The layer width or thickness can however also be significantly thicker up to several millimeters.

The basic body 2a is here produced of a suitable metal depending on the use. The coating 5 is composed of a metal or also a high heat resistant metal, for example, nickel, and is applied by thermal spraying or galvanically or chemically. In the thermal spraying methods the optical waveguide 3 is advantageously surrounded by the protective pipe 4. Depending on the use of the temperature measuring component 1, the coating 5 has a high hardness and/or wear resistance. The thickness or width of the coating generally is 200 to 250 μm, however, can also be constructed significantly greater.

The optical waveguide 3 is a glass fiber having a diameter of about 100 to 150 μm. The protective pipe 4 is made of a suitable metal.

For producing the component 1, initially the basic body 2a is manufactured. On the predetermined surface of the basic body 2a, the optical waveguides 3 are fastened with or without protective pipe 4 provisionally in such a way that a temperature measurement can be carried out at the predetermined locations. Subsequently, the predetermined surface is provided with the coating 5 by spraying the coating 5 by, for example, wire frame spraying, plasma spraying, or powder vapor spraying, or is applied galvanically or chemically.

The second embodiment according to FIG. 2 differs from the previous one by the grooves 6 in the surface of the basic body 2a, so that for otherwise equal or identical parts or elements the same reference numerals are used as in the embodiment according to FIG. 1. The grooves 6 here have a semicircular cross section, wherein a diameter of the semicircle corresponds to at least the diameter of an optical waveguide 3 or a protective pipe 4 to be placed in the groove, so that the optical waveguide 3 or the respective pipe 4 can be arranged in the respectively provided measuring plane so as to be guided without play or with possibly little play in the corresponding groove 6.

A third embodiment illustrated in FIG. 3, in which equal or identical parts or elements are provided again with reference numerals identical to those of FIGS. 1 and 2, relates to a one-part or multiple-part tube mold 7 with rectangular cross section. The basic body 2a of the tube mold 7 consisting of the basic material 2 is preferably made of copper and has on its outer side, the so-called cooling side, cooling ducts 8 which are distributed at the outer side. Of the cooling ducts 8, which have a rectangular, or, if desired, also a semicircular cross section, only two are illustrated as examples. In at least one cooling duct 8, in each cooling duct 8 herein, is arranged at least one waveguide 3 on its base, i.e., the inner side, the so-called hot side, of the side of the cooling duct 8 adjacent to tube mold 7. As described in connection with the first embodiment, the optical waveguides 3 are fastened and surrounded by a coating 5. Alternatively and/or additionally, optical waveguides 3 are arranged at the inner walls of the basic body 2a on the hot side of the tube mold 7, wherein the optical waveguides 3 are covered by a coating 5. In this case, the coating 5 totally covers the inner walls and may have the thickness or width which is conventional in tube molds. The mold preferably is a mold as it is used in a continuous casting plant. Since the mold plates or mold tubes or tube mold 7 of continuous casting plants are frequently galvanically coated on their hot side with nickel, the coating 5 on the hot side of the tube mold 7 is in the embodiment also of nickel and the coating material 5a nickel is galvanically applied to the basic material 2, for example, steel.

Otherwise, the comments concerning the other embodiments are applicable.

In all embodiments, the optical waveguides 3 are connected to an appropriate evaluating unit.

Even if a temperature measuring component 1 with an optical waveguide 3 embedded according to the invention is described above, it is possible to provide in an analogous and preferably identical manner instead of the temperature measuring component 1, a strain measuring component, not shown in detail, with an optical waveguide for measuring mechanical strains and, thus, constructed as a strain measuring sensor or as the component of a strain measuring sensor.

1-17. (canceled)

18. A method of integrating an optical waveguide of a temperature and/or strain measuring sensor into a temperature and/or strain measuring component which is composed of a basic material with a coating applied thereon, the method comprising the steps of: arranging the optical waveguide in, on or at a plane of the temperature and/or strain measuring component defining the basic material of the temperature and/or strain measuring component and forming an intended measuring plane; and subsequently applying a coating material on the plane of the temperature and/or measuring component defining the basic material so as to form a coating that integrally connects the optical waveguide or a pipe surrounding the optical waveguide to the basic material and/or adjacent coating areas, wherein the temperature and/or strain measuring component is at least part of a mold, mold plate or tube mold, wherein the basic material and the coating material are metal or at least essentially metal, the coating being applied by thermal spraying or galvanic or chemical coating.

19. The method according to claim 18, including initially manufacturing a part of the temperature and/or strain measuring component which contains the measuring plane and is composed of the basic material with applied coating, subsequently partially removing the coating up to the measuring plane in an area, arranging at least one optical waveguide or an optical waveguide with surrounding pipe in the area, and finally building the coating up again.

20. The method according to claim 18, including cutting grooves or boring holes in the measuring plane in the basic material, placing the optical waveguide or the pipe surrounding the optical waveguide at least over portions or partially in a respective groove or a respective hole, and applying the coating.

21. The method according to claim 18, including using a material as the coating material which is the same as the basic material.

22. The method according to claim 18, including using a material as the coating material which is different from the basic material.

23. The method according to claim 18, including applying the coating in a thickness of 200 μm-5 mm.

24. The method according to claim 23, including applying the coating in a thickness of 200 μm-250 μm.

25. The method according to claim 18, including applying the coating in a thickness of greater than 250 μm up to several millimeters.

26. The method according to claim 18, including arranging the optical waveguide in, on or at the temperature and/or strain measuring component which is part of a component which receives a hot fluid and/or surrounds a hot fluid.

27. The method according to claim 18, including arranging the at least one optical waveguide, or the at least one pipe surrounding the optical waveguide on a hot side of a mold or mold plate or tube mold.

28. The method according to claim 18, including arranging the at least one optical waveguide or the at least one pipe surrounding the optical waveguide in a cooling duct on a side of a mold, mold plate or a tube mold facing away from a hot side.

29. A measuring component, comprising: an integrated optical waveguide of a temperature and/or strain measuring sensor; a basic material; and a coating applied to the basic material, wherein the optical waveguide is arranged in an intended measuring plane and is covered by the coating, wherein the optical waveguide is arranged in, on or at a plane of the temperature and/or strain measuring component defining the basic material of the temperature and/or strain measuring component and forming an intended measuring plane of the temperature and/or strain measuring component, the optical waveguide being secured in the plane of the temperature and/or strain measuring component defining the basic material by the coating which integrally connects the optical waveguide or a pipe surrounding the waveguide to the basic material and/or adjacent coating areas, wherein the temperature and/or strain measuring component is at least part of a mold, mold plate or tube mold and the basic material and the coating material are a metal or at least substantially a metal.

30. The measuring component according to claim 29, manufactured by arranging the optical waveguide in, on or at a plane of the temperature and/or strain measuring component defining the basic material of the temperature and/or strain measuring component and forming an intended measuring plane; and subsequently applying a coating material on the plane of the temperature and/or measuring component defining the basic material so as to form a coating that integrally connects the optical waveguide or a pipe surrounding the optical waveguide to the basic material and/or adjacent coating areas, wherein the temperature and/or strain measuring component is at least part of a mold, mold plate or tube mold, wherein the basic material and the coating material are metal or at least essentially metal, the coating being applied by thermal spraying or galvanic or chemical coating.

31. The measuring component according to claim 29, wherein the optical waveguide or the pipe surrounding the optical waveguide is embedded in the coating.

32. The measuring component according to claim 29, wherein the basic material has a groove and the optical waveguide or the pipe surrounding the optical waveguide is received in the groove in the basic material.

33. The measuring component according to claim 29, wherein the coating has a thickness of 200 μm-5 mm.

34. The measuring component according to claim 33, wherein the coating has a thickness of 200 μm-250 μm.

35. The measuring component according to claim 29, wherein the coating has a thickness of greater than 250 μm up to several millimeters.

36. The measuring component according to claim 29, wherein the at least one optical waveguide or the at least one pipe surrounding the optical waveguide is arranged on a hot side of the mold, mold plate or tube mold.

37. The measuring component according to claim 29, wherein the at least one optical waveguide or the pipe surrounding the optical waveguide is arranged in a cooling duct on a side of a mold, mold plate or tube mold facing away from a hot side.
